(19) United States
(12) Patent Application Publication
(10) Pub. No.: US 2005/0195592 A1
(43) Pub. Date: Sep. 8, 2005

(54) Handsaw having sawing guide function

(76) Inventors: Hung - Chi Hsu, Tainan (TW); Hung - Lung Hsu, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/796,518

(22) Filed: Mar. 8, 2004

(51) Int. Cl. B25B 23/18

(52) U.S. Cl. 362/120; 30/514; 30/517

(57) ABSTRACT

A handsaw includes a handle, a blade mounted on the handle, and a light emitting member mounted on the handle to produce a longitudinal light source aligning with a lower edge of the blade. Thus, the sawing line of the workpiece and the longitudinal light source of the light emitting member are directed in the same direction, so that a worker can drive the blade to move in the common direction indicated by the sawing line of the workpiece and the longitudinal light source of the light emitting member to cut the workpiece exactly, thereby facilitating the worker sawing the workpiece, and thereby greatly enhancing precision of sawing the workpiece.

### BACKGROUND OF THE INVENTION

1. Field of the Invention

The present invention relates to a handsaw, and more particularly to a handsaw having a sawing guide function.

2. Description of the Related Art

A conventional handsaw comprises a handle, and a blade mounted on the handle. In practice, a worker can drive the blade to move in the direction indicated by a sawing line drawn on a workpiece so as to cut the workpiece according to the sawing line of the workpiece. However, the blade is easily vibrated or inclined during the sawing process due to an unevenly distributed force applied by the worker, so that the blade is easily deflected from the sawing line of the workpiece, thereby greatly decreasing precision of sawing the workpiece.

### SUMMARY OF THE INVENTION

The primary objective of the present invention is to provide a handsaw having a sawing guide function.

Another objective of the present invention is to provide a handsaw, wherein the sawing line of the workpiece and the longitudinal light source of the light emitting member are directed in the same direction, so that a worker can drive the blade to move in the common direction indicated by the sawing line of the workpiece and the longitudinal light source of the light emitting member so as to cut the workpiece exactly, thereby facilitating the worker sawing the workpiece, and thereby greatly enhancing precision of sawing the workpiece.

A further objective of the present invention is to provide a handsaw, wherein the transverse light source of the light emitting member is aligning with the transverse edge of the workpiece constantly, so that the blade is kept at a vertical state relative to the workpiece, thereby enhancing precision of sawing the workpiece.

In accordance with the present invention, there is provided a handsaw, comprising:
a handle;
a blade mounted on the handle; and
a light emitting member mounted on the handle to produce a longitudinal light source aligning with a lower edge of the blade and extending outward from the lower edge of the blade.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a handsaw in accordance with the preferred embodiment of the present invention;

FIG. 2 is a plan view of the handsaw as shown in FIG. 1;

FIG. 3 is a perspective view of a handsaw in accordance with another embodiment of the present invention;

FIG. 4 is a perspective view of a handsaw in accordance with another embodiment of the present invention; and

FIG. 5 is a perspective view of a handsaw in accordance with another embodiment of the present invention.

### DETAILED DESCRIPTION OF THE INVENTION

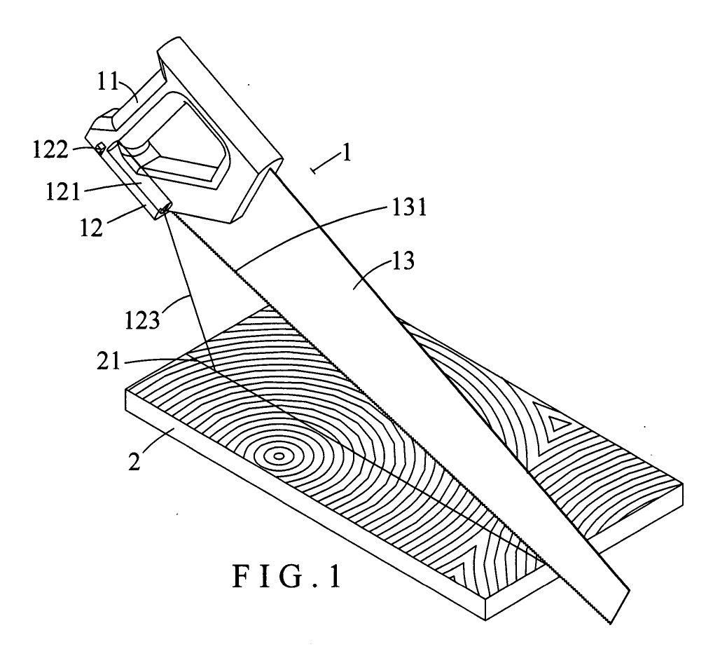

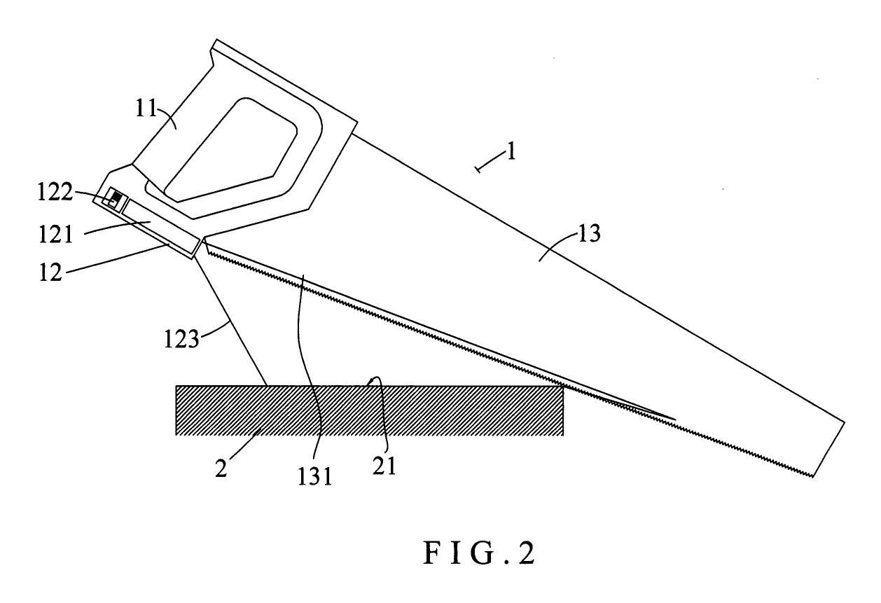

Referring to the drawings and initially to FIGS. 1 and 2, a handsaw 1 in accordance with the preferred embodiment of the present invention comprises a handle 11, a blade 13 mounted on the handle 11, a chamber 12 mounted on a side of the handle 11, a light emitting member 121 mounted in the chamber 12 to produce a longitudinal light source 123 aligning with a lower edge 131 of the blade 13 and extending outward from the lower edge 131 of the blade 13, and a switch 122 mounted on a side of the chamber 12 and connected to the light emitting member 121 to control operation of the light emitting member 121.

Preferably, the longitudinal light source 123 of the light emitting member 121 is a laser light and has a planar shape. In addition, the light emitting member 121 has an inside provided with a battery and a circuit board.

In practice, the switch 122 is operated to turn on the light emitting member 121, so that the longitudinal light source 123 of the light emitting member 121 is projected onto a surface of a workpiece 2 to align with a sawing line 21 of the workpiece 2. Thus, the sawing line 21 of the workpiece 2 and the longitudinal light source 123 of the light emitting member 121 are directed in the same direction, so that a worker can drive the blade 13 to move in the common direction indicated by the sawing line 21 of the workpiece 2 and the longitudinal light source 123 of the light emitting member 121 so as to cut the workpiece 2 exactly, thereby facilitating the worker sawing the workpiece 2, and thereby enhancing precision of sawing the workpiece 2.

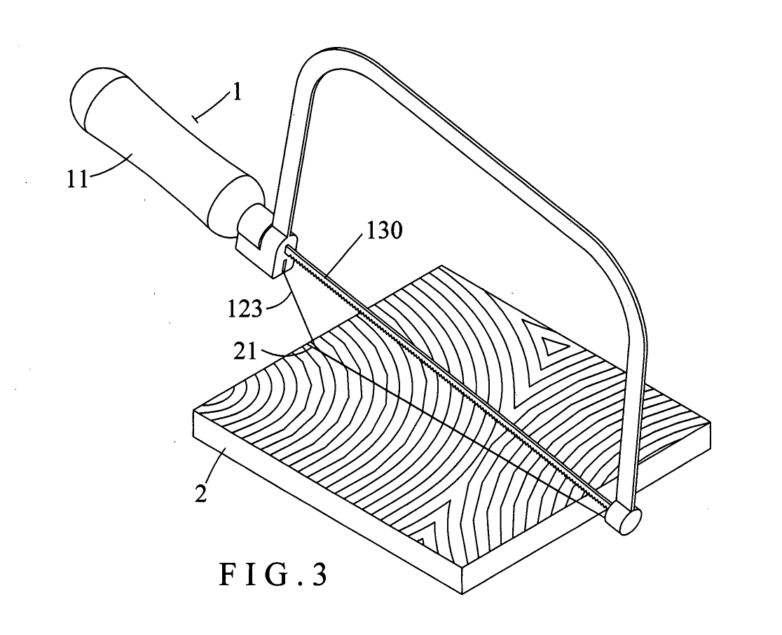

Referring to FIG. 3, the handsaw 1 comprises a blade 130 of a different shape.

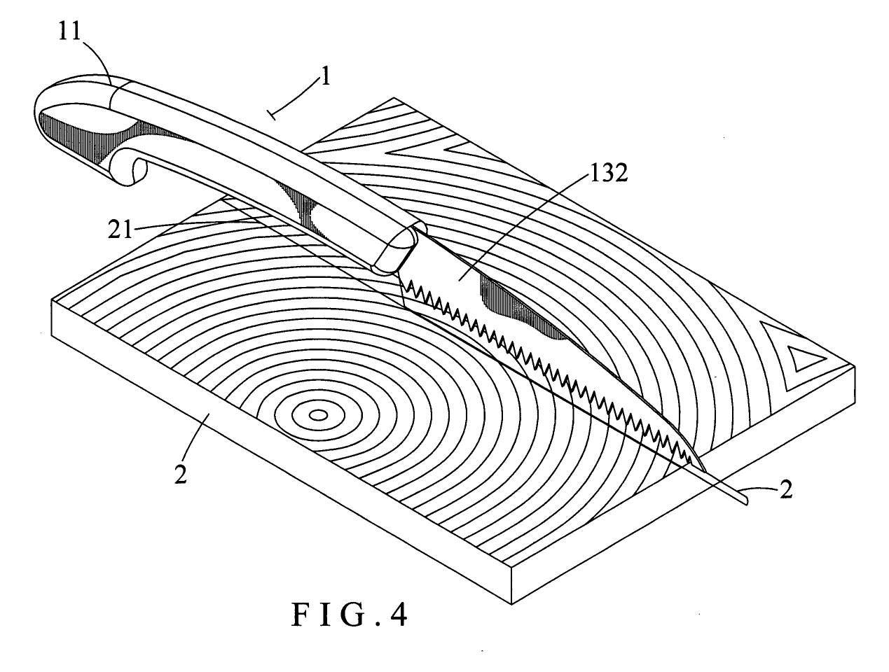

Referring to FIG. 4, the handsaw 1 comprises a blade 132 of a different shape.

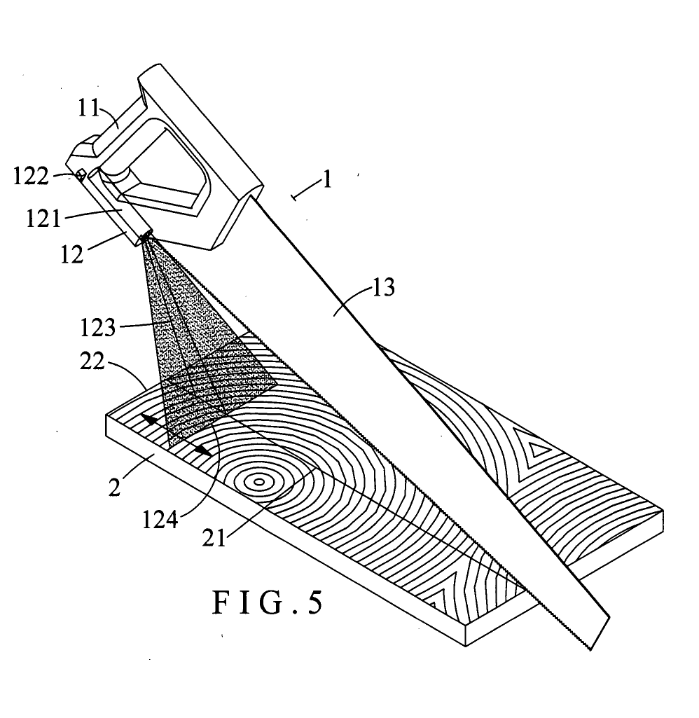

Referring to FIG. 5, the light emitting member 121 further produces a transverse light source 124 moved with movement of the blade 13 and aligning with a transverse edge 22 of the workpiece 2. Preferably, the transverse light source 124 of the light emitting member 121 is a laser light and has a planar shape. In addition, the transverse light source 124 of the light emitting member 121 is perpendicular to the longitudinal light source 123 of the light emitting member 121.

In practice, the transverse light source 124 of the light emitting member 121 is aligning with the transverse edge 22 of the workpiece 2 constantly, so that the blade is kept at a vertical state relative to the workpiece 2, thereby enhancing precision of sawing the workpiece 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A handsaw, comprising:
a handle;
a blade mounted on the handle; and
a light emitting member mounted on the handle to produce a longitudinal light source aligning with a lower edge of the blade and extending outward from the lower edge of the blade.

2. The handsaw in accordance with claim 1, wherein the longitudinal light source of the light emitting member is a laser light.

3. The handsaw in accordance with claim 1, wherein the longitudinal light source of the light emitting member has a planar shape.

4. The handsaw in accordance with claim 1, wherein the light emitting member has an inside provided with a battery and a circuit board.

5. The handsaw in accordance with claim 1, further comprising a chamber mounted on a side of the handle, wherein the light emitting member is mounted in the chamber.

6. The handsaw in accordance with claim 5, further comprising a switch mounted on a side of the chamber and connected to the light emitting member to control operation of the light emitting member.

7. The handsaw in accordance with claim 1, wherein the longitudinal light source of the light emitting member is projected onto a surface of a workpiece to align with a sawing line of the workpiece.

8. The handsaw in accordance with claim 7, wherein the sawing line of the workpiece and the longitudinal light source of the light emitting member are directed in the same direction.

9. The handsaw in accordance with claim 1, wherein the blade has different shapes.

10. The handsaw in accordance with claim 1, wherein the light emitting member further produces a transverse light source moving with the blade and aligning with a transverse edge of a workpiece.

11. The handsaw in accordance with claim 10, wherein the transverse light source of the light emitting member is a laser light.

12. The handsaw in accordance with claim 10, wherein the transverse light source of the light emitting member has a planar shape.

13. The handsaw in accordance with claim 10, wherein the transverse light source of the light emitting member is perpendicular to the longitudinal light source of the light emitting member.
